(19) United States
(12) Patent Application Publication
(10) Pub. No.: US 2022/0246919 A1
(43) Pub. Date: Aug. 4, 2022

(54) NEGATIVE ELECTRODE FOR NONAQUEOUS ELECTROLYTE SECONDARY BATTERIES AND NONAQUEOUS ELECTROLYTE SECONDARY BATTERY INCLUDING THE SAME

(71) Applicant: HONDA MOTOR CO.LTD., Tokyo (JP)

(72) Inventors: Kiyoshi TANAAMI, Saitama (JP); Toshimitsu TANAKA, Saitama (JP); Yuji ISOGAI, Saitama (JP); Makiko TAKAHASHI, Saitama (JP); Shintaro AOYAGI, Saitama (JP); Takashi MUKAI, Osaka (JP); Yuta IKEUCHI, Osaka (JP); Taichi SAKAMOTO, Osaka (JP); Naoto YAMASHITA, Osaka (JP)

(21) Appl. No.: 17/585,587

(22) Filed: Jan. 27, 2022

(30) Foreign Application Priority Data
Feb. 1, 2021 (JP) 2021-014106

(51) Int. Cl. H01M 4/36; H01M 4/66; H01M 4/80; H01M 4/137; H01M 4/134; H01M 4/60; H01M 4/38; H01M 10/0525

(52) U.S. Cl. CPC H01M 4/366; H01M 4/661; H01M 4/808; H01M 4/137; H01M 2004/027; H01M 4/604; H01M 4/386; H01M 10/0525; H01M 4/134

(57) ABSTRACT

To provide a negative electrode for nonaqueous electrolyte secondary batteries, by which durability deterioration and structural deterioration of the electrode is suppressed, and cycle durability and energy density can be improved by suppressing generation of voids in the inside of the porous metal, and a nonaqueous electrolyte secondary battery including the same. A negative electrode for nonaqueous electrolyte secondary batteries, having
a current collector made of porous metal, and a negative electrode material placed in pores of the porous metal, the negative electrode material including a first negative electrode active material placed on an internal surface of each of the pores and including a silicon-based material; a skeleton forming agent placed on the first negative electrode active material and including a silicate having a siloxane bond; and a second negative electrode active material placed on the skeleton forming agent.

This application is based on and claims the benefit of priority from Japanese Patent Application No. 2021-014106, filed on 1 Feb. 2021, the content of which is incorporated herein by reference.

### BACKGROUND OF THE INVENTION

### Field of the Invention

The present invention relates to a negative electrode for nonaqueous electrolyte secondary batteries, and a nonaqueous electrolyte secondary battery including the same.

### Related Art

In recent years, nonaqueous electrolyte secondary batteries such as lithium-ion secondary batteries are small and light and also have high power, and thus have been increasingly used for e.g. cars. The nonaqueous electrolyte secondary battery is a battery system using an electrolyte, which does not contain water as a main component, as the electrolyte thereof, and is a generic name for storage devices which can be charged and discharged. For example, lithium-ion batteries, lithium polymer batteries, all-solid-state lithium batteries, lithium air batteries, lithium sulfur batteries, sodium ion batteries, potassium ion batteries, multivalent ion batteries, fluoride batteries, sodium sulfur batteries and the like are known. This nonaqueous electrolyte secondary battery includes mainly a positive electrode, a negative electrode and an electrolyte. In addition, when an electrolyte has fluidity, the nonaqueous electrolyte secondary battery further includes a separator between the positive electrode and the negative electrode.

For the purpose of improving battery life, for example, a technique in which a skeleton forming agent including a silicate having a siloxane bond is allowed to exist at least on the surface of an active material and the skeleton forming agent is allowed to permeate from the surface to the inside thereof is disclosed (see e.g. Patent Document 1). Because a strong skeleton can be formed on an active material by this technique, it is considered that the battery life can be improved. In addition, a technique for applying the above skeleton forming agent to a negative electrode including a silicon (Si)-based active material is also disclosed (see e.g. Patent Document 2).

Patent Document 1: Japanese Patent No. 6369818

Patent Document 2: Japanese Patent No. 6149147

### SUMMARY OF THE INVENTION

In the above nonaqueous electrolyte secondary batteries, incidentally, an improvement in energy density has been demanded. It is considered that in order to improve energy density, an increase in the film thickness of a negative electrode and an increase in the density of the amount of a negative electrode active material are effective. By conventional techniques, however, the thickness of the negative electrode is limited in the production of negative electrodes. Specifically, the practical thickness of a film thickness, at which a mixture layer can be applied to conventional current collector foil, is less than 100 mm. When the film thickness is 100 mm or more, problems such as coating unevenness, cracks and peeling are caused, and it is difficult to produce a high accuracy negative electrode.

In addition, because of a balance between the binding power of a binder and the expansion and contraction of a negative electrode active material, the amount of the negative electrode active material per unit area is limited from the viewpoint of durability. Specifically, the limit of the capacity of a negative electrode active material per unit area is about 4 mAh/cm² (film thickness 50 mm), and when the capacity is equal to or greater than the limit, sufficient cycle characteristics cannot be retained. Conversely, when the capacity of an active material is less than 4 mAh/cm², an improvement in energy density cannot be expected.

In order to solve the above problems, it is considered to use porous metal for a negative electrode current collector for nonaqueous electrolyte secondary batteries and to pack an electrode mixture in the porous metal. In a case where in nonaqueous electrolyte secondary batteries, a current collector made of porous metal, an electrode active material including a silicon-based material as a negative electrode active material, and a skeleton forming agent to coat the current collector and the electrode active material are used for the negative electrode, when the skeleton forming agent permeates into the inside of the negative electrode insufficiently, it has been found that voids is created inside the porous metal. In a nonaqueous electrolyte secondary battery to which such negative electrode is applied, it has been also found that structural deterioration occurs in the inside of the electrode by repeating charge and discharge, and thus battery performance becomes deteriorated.

Therefore, a negative electrode for nonaqueous electrolyte secondary batteries, by which durability deterioration and structural deterioration of the electrode is suppressed, and cycle durability and energy density can be improved by suppressing generation of voids in the inside of the porous metal, and a nonaqueous electrolyte secondary battery including the same are demanded.

The present invention has been made in view of the above, and an object thereof is to provide a negative electrode for nonaqueous electrolyte secondary batteries, by which durability deterioration and structural deterioration of the electrode is suppressed, and cycle durability and energy density can be improved by suppressing generation of voids in the inside of the porous metal, and a nonaqueous electrolyte secondary battery including the same.

(1) In order to achieve the object, the present invention provides a negative electrode for nonaqueous electrolyte secondary batteries having a current collector composed of a porous metal, and a negative electrode material placed in pores of the porous metal, in which the negative electrode material contains a first negative electrode active material placed on an internal surface of each of the pores and composed of a silicon-based material; a skeleton forming agent placed on the first negative electrode active material and containing a silicate having a siloxane bond; a second negative electrode active material placed on the skeleton forming agent.

(2) In the negative electrode for nonaqueous electrolyte secondary batteries of (1), the negative electrode material may be further provided with a conductive additive placed between the skeleton forming agent and the second negative electrode active material.

(3) In the negative electrode of a nonaqueous electrolyte secondary battery of (1) or (2), the skeleton forming agent may contain a silicate expressed by the following formula (1).

[Chem. 1]

A₂O.nSiO₂ formula (1)

[In the general formula (1), A represents an alkali metal.]

(4) In the negative electrode for nonaqueous electrolyte secondary batteries of any one of (1) to (3), the porous metal may be a foamed metal.

(5) Furthermore, the present invention provides a nonaqueous electrolyte secondary battery, including the negative electrode for nonaqueous electrolyte secondary batteries of any one of (1) to (4).

According to the present invention, by suppressing the generation of voids inside of a porous metal body, a negative electrode for nonaqueous electrolyte secondary batteries that may suppress endurance deterioration, and at the same time, may improve an energy density and a nonaqueous electrolyte secondary battery with the same are provided.

### BRIEF DESCRIPTION OF THE DRAWINGS

FIG. 1 is a drawing which schematically shows a constitution of a negative electrode for nonaqueous electrolyte secondary batteries according to a first embodiment of the present invention;

FIG. 2 is a drawing which schematically shows a constitution of a negative electrode for nonaqueous electrolyte secondary batteries, when the first embodiment of the present invention further includes a conductive additive and a binder; and

FIG. 3 is a drawing which shows the relation between the number of cycles and the capacity of active material (mAh/g) of examples 1 to 4 and a comparative example 1.

### DETAILED DESCRIPTION OF THE INVENTION

The first embodiment of the present invention will now be described in detail with reference to the drawings.

[Negative Electrode]

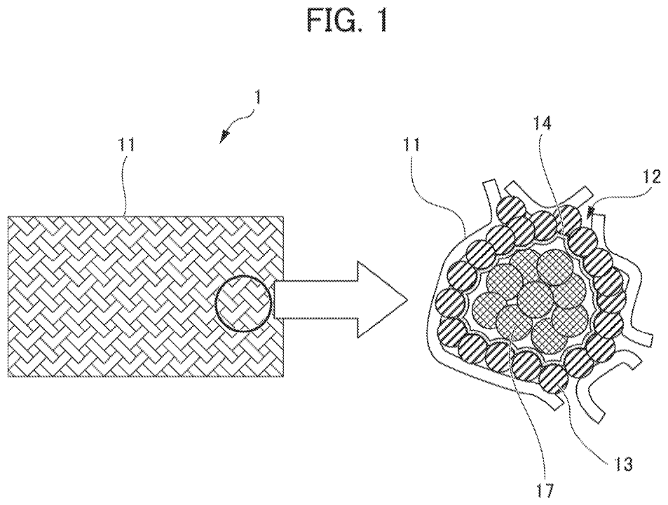

FIG. 1 is a drawing which schematically shows the constitution of a negative electrode 1 for nonaqueous electrolyte secondary batteries according to the present embodiment. The negative electrode 1 for nonaqueous electrolyte secondary batteries according to the present embodiment has a current collector 11 made of porous metal, and a negative electrode material 12 placed in pores of the porous metal. Furthermore, the negative electrode material 12 includes a first negative electrode active material 13 placed on an internal surface of the pore and made of a silicon-based material, a skeleton forming agent 14 placed on the first negative electrode active material 13 and including a silicate having a siloxane bond, and a second negative electrode active material 17 placed on the skeleton forming agent. For example, by using the present embodiment for a negative electrode for lithium-ion secondary batteries, it is possible to provide a negative electrode for lithium-ion secondary batteries, by which durability deterioration and structural deterioration of the electrode is suppressed, and cycle durability and energy density can be improved by suppressing generation of voids in the inside of the porous metal, and a lithium-ion secondary battery including the same. A case where the present embodiment is used for a negative electrode for lithium-ion secondary batteries will now be described in detail. It should be rioted, however, that a variety of additions, modifications or deletions can be made without departing from the spirit of the present invention.

As the current collector 11, a current collector 11 made of porous metal is used. A mesh, a woven fabric, a non-woven fabric, an embossed metal, a punched metal, an expanded metal, a foam and the like are shown as examples, and a metal foam is preferably used. Among these, a metal foam having a three dimensional network structure with continuous pores is preferably used, and for example Celmet (registered trademark) (manufactured by Sumitomo Electric Industries, Ltd.) and the like can be used.

The material of porous metal is not particularly limited as long as it is a material which has electron conductivity and can apply current to a retained electrode material, and, for example, conductive metals such as Al, Al alloys, Ni, Ni—Cr alloys, Fe, Cu, Ti, Cr, Au, Mo, W, Ta, Pt, Ru and Rh, conductive alloys containing two or more of these conductive metals (stainless steel (such as SUS304, SUS316, SUS316L and YUS270) and the like can be used. In addition, when using a material other than the above conductive metals or conductive alloys, for example, a multi-layered structure of different metals in which Fe is covered with Cu or Ni may be used. Among these, because electron conductivity and reduction-resistant properties are excellent, Ni or a Ni alloy is preferably used.

The thickness of porous metal is preferably 10 mm or more and more preferably 50 mm or more. The thickness of porous metal is preferably 1 mm or less and more preferably 800 mm or less.

The average pore diameter of porous metal is preferably 800 mm or less. When the average pore diameter of porous metal is within this range, a distance between the first negative electrode active material 13 packed or supported in the inside of porous metal and the metal skeleton becomes stable, and electron conductivity is improved to suppress an increase in the internal resistance of a battery. In addition, even when volume changes occur with charge and discharge, falling of an electrode mixture can be suppressed.

The specific surface area of porous metal is preferably 1000 to 10000 m²/m³. This is twice to 10 times larger than the specific surface area of conventionally common current collector foil. When the specific surface area of porous metal is within this range, the contact properties of an electrode mixture and the current collector 11 are improved and an increase in the internal resistance of a battery is suppressed. The specific surface area is more preferably 4000 to 7000 m²/m³.

The porosity of porous metal is preferably 90 to 99%. When the porosity of porous metal is within this range, the amount of an electrode mixture packed can be increased, and the energy density of a battery is improved. Specifically, when the porosity is above 99%, the mechanical strength of porous metal is significantly reduced, and the porous metal is easily broken by changes in the volume of an electrode with charge and discharge. Conversely, when the porosity is less than 90%, not only the amount of an electrode mixture packed is reduced, but also the ion conductivity of an electrode is reduced, and thus it is difficult to obtain sufficient input and output characteristics. From these viewpoints, the porosity is more preferably 93 to 98%.

The basis weight of the electrode of porous metal is preferably 1 to 100 mg/cm². When the basis weight of the electrode by porous metal is within this range, the capacity of an active material can be sufficiently expressed, and the capacity as designed as the electrode can be shown. The basis weight of the electrode is more preferably 5 to 60 mg/cm².

As the first negative electrode active material 13, one which can reversibly absorb and release lithium ion is used, and specifically a negative electrode active material including a high capacity of silicon-based material is used. Elemental silicon, silicon alloys, silicon oxides, silicon compounds and the like correspond to the silicon-based material. Here, elemental silicon indicates crystalline or amorphous silicon with a purity of 95 mass % or more. The silicon alloys mean Si-M alloys including silicon and another transition element M. Examples of M include Al, Mg, La, Ag, Sn, Ti, Y, Cr, Ni, Zr, V, Nb, Mo and the like, and the silicon alloy may be an all-proportional solid solution alloy, a eutectic alloy, a hypo-eutectic alloy, a hyper-eutectic alloy or a peritectic alloy. The silicon oxides mean oxides of silicon or composites including elemental silicon and SiO₂, and the element ratio of Si and U is only required to be 1 and 1.7 or less. The silicon compounds are substances in which silicon and other two or more elements are chemically bound. Among these, elemental silicon is preferred because an interfacial layer described below can be formed well. Alternatively, a substance in which a carbon-based material is mixed or composited with a silicon-based material can be also used.

In the present invention, the first negative electrode active material 13 is preferably placed on an internal surface of pores of the porous metal.

The shape of the silicon-based material is not particularly limited, and the material may be spherical, oval, faceted, strip, fibrous, flake, doughnut-shaped or hollow powder, and these may be in single grain shape or agglomerated shape.

The negative electrode active material 13 including a silicon-based material has an expansion coefficient of 10% or more by charge and discharge. That is, although the negative electrode active material 13 largely expands and contracts during charge and discharge, durability deterioration by such expansion and contraction can be suppressed by using the skeleton forming agent 14 described below.

The particle diameter of the silicon-based material is preferably 1.0 mm to 15 mm from the viewpoint of obtaining excellent cycle characteristics of the electrode and high input and output characteristics.

From the viewpoint of securing conductivity during expansion and contraction of the active material during charge and discharge, the carrying amount (basis weight) of the first negative electrode active material 13 is preferably 1.0 to 12 mg/cm². The carrying amount (basis weight) of the first negative electrode active material 13 is more preferably 2.0 to 8.0 mg/cm².

The first negative electrode active material 13 may also include a carbon-based material (such as graphite, hard carbon or soft carbon) and/or a conductive additive 15 in addition to the above silicon-based material. When the first negative electrode active material 13 includes the carbon-based material and/or the conductive additive 15, from the viewpoint of an output improvement of the battery, when the total of the first negative electrode active material 13, the carbon-based material and the conductive additive 15 is considered to be 100 mass %, the amount of the conductive additive 15 included is preferably 1 to 10 mass %. The amount of the conductive additive 15 included is more preferably 2 to 7 mass %.

As the skeleton forming agent 14, a skeleton forming agent 14 including a silicate having a siloxane bond is used. More specifically, the skeleton forming agent 14 preferably includes a silicate represented by general formula (1) below.

[Chem. 2]

A₂O.nSiO₂ formula (1)

In the above general formula (1), A represents an alkali metal. In particular, A is preferably at least any one of lithium (Li), sodium (Na) and potassium (K). A lithium-ion secondary battery with high strength, excellent heat resistance and excellent cycle life is obtained by using such alkali metal salt of silicic acid having a siloxane bond as the skeleton forming agent.

In the above general formula (1), n is preferably 1.6 or more and 3.9 or less. When n is within this range, moderate viscosity is obtained when the skeleton forming agent 14 and water are mixed to form a skeleton forming agent liquid, and when the liquid is applied to a negative electrode including silicon as the negative electrode active material 13 as described below, the skeleton forming agent 14 easily permeates into the negative electrode material 12. This further ensures that a lithium-ion secondary battery with high strength, excellent heat resistance and excellent cycle life is obtained.

n is more preferably 2.0 or more and 3.5 or less.

The above silicate is preferably an amorphous silicate. Amorphous silicates have an unregulated molecular arrangement, and thus unlike crystals do not break in a particular direction. Because of this, cycle life characteristics are improved by using an amorphous silicate as the skeleton forming agent 14.

The skeleton forming agent 14 permeates between the first negative electrode active materials 13, for example, by applying the above skeleton forming agent liquid to a negative electrode including silicon as the first negative electrode active material 13. At this time, it is presumed that silicon to make the negative electrode active material 13 and the above silicate to make the skeleton forming agent 14 are mixed, and, for example, a hydrolyzed silicate is then dehydrated by heating (condensation reaction of silanol group) to form a siloxane bond (—Si—O—Si—). That is, in the negative electrode 1 for lithium-ion secondary batteries in the present embodiment, an interfacial layer including an inorganic substance is formed on the interface between the first negative electrode active material 13 and the skeleton forming agent 14, and in this interfacial layer, silicon derived from the siloxane bond and an alkali metal generated from e.g. hydrolysis of a silicate are included. It is assumed that the first negative electrode active material 13 and the skeleton forming agent 14 are strongly bound by the existence of the interfacial layer, and as a result, excellent cycle life characteristics are obtained since the first negative electrode active material 13 is fixed or carried in the inside of the porous metal by a metal skeleton of the current collector 11 and the skeleton forming agent 14. In the present invention, the skeleton forming agent 14 is preferably placed on the first negative electrode active material 13. This is because a metal skeleton of the current collector 11 made of the porous metal and the skeleton forming agent 14 may fix or carry the first negative electrode active material 13 in the inside of pores of the porous metal.

In the present embodiment, the proportion of an alkali metal atom to all atoms to make the interfacial layer is preferably higher than the proportion of the alkali metal atom to all atoms to make the skeleton forming agent 14. More specifically, the proportion of an alkali metal atom to all atoms to make the interfacial layer is preferably 5 times or more higher than the proportion of the alkali metal atom to all atoms to make the skeleton forming agent 14. Because of this, the bond of the first negative electrode active material 13 and the skeleton forming agent 14 becomes stronger. Therefore, peeling by the expansion and contraction of the first negative electrode active material 13 during charge and discharge, and wrinkles and cracking of the current collector 11 are further suppressed, and cycle life is further improved.

The thickness of the above interfacial layer is preferably 3 to 30 nm. When the thickness of the interfacial layer is within this range, the bond of the first negative electrode active material 13 and the skeleton forming agent 14 becomes stronger. Therefore, peeling by the expansion and contraction of the first negative electrode active material 13 during charge and discharge, and wrinkles and cracking of the current collector 11 are further suppressed, and cycle life is further improved.

The skeleton forming agent 14 of the present embodiment may include a surfactant. Because of this, the lyophilic properties of the skeleton forming agent 14 in the negative electrode material 12 are improved, and the skeleton forming agent 14 uniformly permeates into the negative electrode material 12. Therefore, a uniform skeleton is formed among the first negative electrode active materials 13 in the negative electrode material 12 and cycle life characteristics are further improved.

The amount of the skeleton forming agent 14 included in the negative electrode material 12 (density) is preferably 0.5 to 2.0 mg/cm². When the amount of the skeleton forming agent 14 included in the negative electrode material 12 is within this range, the above-described effect by using the skeleton forming agent 14 is more certainly displayed.

When the total solid content in the first negative electrode active material 13, the skeleton forming agent 14 and the second negative electrode active material 17 is considered to be 100 mass %, the amount of the skeleton forming agent 14 included is preferably 3.0 to 40.0 mass %. When the amount of the skeleton forming agent 14 included is within this range, the above-described effect by using the skeleton forming agent 14 is more certainly displayed. When the amount of the skeleton forming agent 14 included in the negative electrode material 12 is 3.0 mass % or more, the function of the skeleton forming agent 14 is more sufficiently obtained.

In addition, when the amount of the skeleton forming agent 14 included is 40 mass % or less, a reduction in energy density can be further prevented. The amount of the skeleton forming agent 14 included is more preferably 5.0 to 30.0 mass %.

Here, in the negative electrode 1 for nonaqueous electrolyte secondary batteries of the present embodiment, the skeleton forming agent 14 is placed at least on the interface with the current collector 11 in the negative electrode material 12. More specifically, the skeleton forming agent 14 is uniformly placed not only on the interface between the current collector 11 and the negative electrode material 12, but also in the whole negative electrode material 12, and is dispersed among the first negative electrode active materials 13. Conversely, in conventional negative electrodes for nonaqueous electrolyte secondary batteries, the skeleton forming agent unevenly exists on the surface of a negative electrode material.

Furthermore, the negative electrode 1 for lithium-ion secondary batteries according to the present embodiment includes the second negative electrode active material 17. As the second negative electrode active material, a negative electrode active material having a property that does not cause expansion and contraction during charge and discharge or the expansion and contraction is small, is preferably used. It is assumed that falling of the negative electrode material 12 generated during expansion and contraction of the first negative electrode active material 13 is suppressed since, when the skeleton forming agent 14 did not permeate sufficiently into the current collector 11, voids generated in pores can be buried by including the second negative electrode active material 17 in the inside of pores of the current collector 11 made of the porous metal. In the present invention, the second negative electrode active material is preferably placed on the skeleton forming agent. This is because the second negative electrode active material may be placed in the voids generated by placing the first negative electrode active material 13 and the skeleton forming agent 14 in the inside of pores of the porous metal in a described order. It is noted that the second negative electrode active material is different from the first negative electrode active material, and is not necessarily bonded or fixed with the skeleton forming agent. As a specific material preferably used as the second negative electrode active material, silicon monoxide (SiO), silicon carbide (SiC), tin (Sn), graphite, a carbon-based material (such as graphite (Gr), hard carbon, soft carbon), and lithium titanate (LTO) are cited, and one or two or more of these can be used. From the viewpoint of improving the energy density, silicon monoxide is preferred.

The basis weight of the second negative electrode active material is preferably 1 to 40 mg/cm², from the viewpoint of the energy density. The basis weight of the second negative electrode active material is more preferably 5 to 15 mg/cm². Furthermore, the total basis weight of the first negative electrode active material and the second negative electrode active material is preferably 10 to 50 mg/cm² from the viewpoint of suppressing durability deterioration and improving the energy density. A more preferable total basis weight of the first negative electrode active material and the second negative electrode active material is 10 to 20 m/cm². The mixing ratio of the first negative electrode active material and the second negative electrode active material is preferably 1:2 to 1:5 weight ratio from the viewpoint of the energy density. The mixing ratio of the first negative electrode active material and the second negative electrode active material is more preferably 1:2 to 1:3 weight ratio.

The thickness of the negative electrode 1 for a nonaqueous electrolyte secondary battery of the present embodiment having the above constitution is preferably 50 mm to 1000 mm. When the thickness of the negative electrode 1 for a nonaqueous electrolyte secondary battery is within this range, the durability deterioration may be suppressed compared to those of conventional electrodes and the energy density can be improved. The thickness of the negative electrode 1 for a nonaqueous electrolyte secondary battery is more preferably 150 μm to 800 μm.

Furthermore, in the negative electrode 1 for a nonaqueous electrolyte secondary battery of the present embodiment, the distance between the current collector 11 made of the porous metal and the first negative electrode active material 13 is preferably 50 μm or less. The durability deterioration can be suppressed when the distance between the current collector 11 made of the porous metal and the first negative electrode active material 13 is 50 mm or less. The distance between the current collector 11 made of the porous metal and the first negative electrode active material 13 is more preferably 30 mm or less.

It should be noted that the constitution of the negative electrode 1 for lithium-ion secondary batteries according to the present embodiment above may include a conductive additive 15. The conductive additive 15 is not particularly restricted as long as it has electron conductivity, and metal, a carbon material, a conductive polymer, a conductive glass or the like can be used. Specific examples thereof include acetylene black (AB), ketjen black (KB), furnace black (FB), thermal black, lamp black, channel black, roller black, disc black, carbon black (CB), carbon fiber (e.g. vapor grown carbon fiber VGCF (registered trademark)), carbon nanotube (CNT), carbon nanohorn, graphite, graphene, glassy carbon, amorphous carbon and the like, and one or two or more of these can be used. When the conductive additive is included in the present embodiment, the conductivity in the electrode can be improved and the internal resistance can be reduced by using a carbon black-based carbon material, a furnace-based carbon material, or a fibrous carbon material as the conductive additive 15. Furthermore, the structural deterioration of the electrode due to repetition of charge and discharge can be suppressed, and the cycle durability can be improved by using the graphene-based caron material as the conductive additive 15.

When the conductive additive 15 and/or the binder 16 are included in the present embodiment, the amount of the conductive additive 15 included is preferably 0 to 20.0 mass % when the total of the first negative electrode active material 13, the conductive additive 15, the binder 16 and the second negative electrode active material 17 is considered to 100 mass %. When the amount of the conductive additive 15 included is within this range, conductivity can be improved without reducing the capacity density of the negative electrode, and voids which can retain a sufficient amount of the skeleton forming agent 14 in the inside of the negative electrode material 12 can be formed. The amount of the conductive additive 15 included is more preferably 2 to 10 mass %.

When the conductive additive 15 is included in the present embodiment, the conductive additive 15 preferably has a bulk density of 0.04 to 0.25 mg/cm³. When the bulk density of the conductive additive 15 is within this range, the above-described skeleton forming agent 14 can be sufficiently impregnated, and the above-described effect by the skeleton forming agent 14 can be sufficiently displayed. The bulk density of the conductive additive 15 is more preferably 0.04 to 0.15 mg/cm³.

In the present invention, when the conductive additive 15 is included in the negative electrode 1 for a nonaqueous electrolyte secondary battery, the conductive additive 15 is preferably placed between the skeleton forming agent and the second negative electrode active material 17. When the conductive additive 15 is included in the negative electrode 1 for a nonaqueous electrolyte secondary battery of the present embodiment, the conductive additive is placed at least on an interface between the current collector 11 and the negative electrode material 12, specifically on a surface of the current collector 11, the first negative electrode active material 13 and the skeleton forming agent 14 or also in a gap formed by placing them. More specifically, the conductive additive 15 is placed not only on the interface between the current collector 11 and the negative electrode material 12, but also in the whole negative electrode material 12, and is dispersed among the negative electrode active materials 13, and in the gap formed between the current collector 11, the first negative electrode active materials 13 and the skeleton forming agent 14. Contrary to this, when a conventional negative electrode for nonaqueous electrolyte secondary batteries contains the conductive additive, the conductive additive is unevenly distributed on a surface of the negative electrode material.

Furthermore, the negative electrode 1 for lithium-ion secondary batteries according to the present embodiment above may include the binder 16. As the binder 16, for example, organic materials may be used individually, such as polyvinylidene difluoride (PVdF), polytetrafluoroethylene (PTFE), polyimide (PI), polyamide, polyamide-imide, aramid, polyacryl, styrene butadiene rubber (SBR), ethylene-vinyl acetate copolymer (EVA), styrene-ethylene-butylene-styrene copolymer (SEBS), carboxymethyl cellulose (CMC), xanthan gum, polyvinyl alcohol (PVA), ethylene vinylalcohol, polyvinyl butyral (PVB), ethylene vinylalcohol, polyethylene (PE), polypropylene (PP), polyacrylic acid, lithium polyacrylate, sodium polyacrylate, potassium polyacrylate, ammonium polyacrylate, methyl polyacrylate, ethyl polyacrylate, amine polyacrylate, polyacrylic acid ester, epoxy resin, polyethylene terephthalate (PET), polybutylene terephthalate (PBT), nylon, polyvinyl chloride, silicone rubber, nitrile rubber, cyanoacrylate, urea formaldehyde resin, melamine resin, phenol resin, latex, polyurethane, silylated urethane, nitrocellulose, dextrin, polyvinylpyrrolidone, vinyl acetate, polystyrene, chloropropylene, resorcinol resin, polyaromatics, modified silicone, methacrylate resin, polybutene, butyl rubber, 2-propenoic acid, cyanoacrylic acid, methyl methacrylate, glycidyl methacrylate, acrylic oligomer, 2-hydroxyethyl acrylate, alginic acid, starch, lacquer, sucrose, glue, casein and cellulose nanofiber, or two or more of these may be used in combination.

In addition, a binder obtained by mixing each of the above organic binders and an inorganic binder may be used. Examples of inorganic binders include silicate-based, phosphate-based, sol-based, cement-based binders and the like. For example, inorganic materials may be used individually, such as lithium silicate, sodium silicate, potassium silicate, cesium silicate, guanidine silicate, ammonium silicate, hexafluorosilicate, borates, aluminic acid lithium salt, aluminic acid sodium salt, aluminic acid potassium salt, aluminosilicate, lithium aluminate, sodium aluminate, potassium aluminate, polyaluminum chloride, polyaluminum sulfate, polyaluminum sulfate silicate, aluminum sulfate, aluminum nitrate, ammonium alum, lithium alum, sodium alum, potassium alum, chrome alum, iron alum, manganese alum, nickel ammonium sulfate, diatomite, polyzirconoxane, polytantaloxane, mullite, white carbon, silica sol, colloidal silica, fumed silica, alumina sol, colloidal alumina, fumed alumina, zirconia sol, colloidal zirconia, fumed zirconia, magnesia sol, colloidal magnesia, fumed magnesia, calcia sol, colloidal calcia, fumed calcia, titania sol, colloidal titania, fumed titania, zeolite, silicoaluminophosphate zeolite, sepiolite, montmorillonite, kaolin, saponite, aluminum phosphate, magnesium phosphate, calcium phosphate, iron phosphate, copper phosphate, zinc phosphate, titanium phosphate, manganese phosphate, barium phosphate, tin phosphate, low-melting glass, plaster, gypsum, magnesium cement, litharge cement, portland cement, blast furnace cement, fly ash cement, silica cement, phosphate cement, concrete and solid electrolyte, or two or more of these may be used in combination.

When the binder 16 is included in the present embodiment, because the first negative electrode active material 13 and the skeleton forming agent 14 are strongly bound by the above-described interfacial layer formed by using the skeleton forming agent 14, all of the above-described binders can be used. When the conductive additive 15 and/or the binder 16 are included in the present embodiment, in the case where the total of the first negative electrode active material 13, the conductive additive 15, the binder 16 and the second negative electrode active material 17 is considered to be 100 mass %, the amount of the binder 16 included is preferably 0.1 to 60 mass %. When the amount of the binder 16 included is within this range, ion conductivity can be improved without reducing the capacity density of the negative electrode, high mechanical strength is obtained, and more excellent cycle life characteristics are obtained. The amount of the binder 16 included is more preferably 0.5 to 30 mass. In the present invention, when the binder 16 is included in the negative electrode 1 for a nonaqueous electrolyte secondary battery, the binder 16 is preferably placed between the skeleton forming agent 14 and the second negative electrode active material 17, and between particles of the negative electrode active material 17.

When the conductive additive and/or the binder are included in the present embodiment, the amount of the skeleton forming agent 14 included is required to be calculated by considering the solid mass of the conductive additive and the binder. Specifically, the amount of the skeleton forming agent 14 included is preferably 3.0 to 40.0 mass %, considering the total solid content of the negative electrode active material 13, the skeleton forming agent 14, the conductive additive 15, the binder 16, and the second negative electrode active material 17 to be 100 mass %, when the conductive additive and/or the binder are included in the present embodiment. When the amount of the skeleton forming agent 14 included is within this range, the above-described effect by using the skeleton forming agent 14 is more certainly displayed. When the amount of the skeleton forming agent 14 included in the negative electrode material 12 is 3.0 mass % or more, the function of the skeleton forming agent 14 is more sufficiently obtained.

In addition, when the amount of the skeleton forming agent 14 included is 40 mass % or less, a reduction in energy density can be further prevented. The amount of the skeleton forming agent 14 included is more preferably 5.0 to 30.0 mass %.

[Positive Electrode]

A positive electrode when making a lithium-ion secondary battery using the above-described negative electrode will now be described. The positive electrode active material is not particularly limited as long as it is a positive electrode active material which is commonly used for lithium-ion secondary batteries. For example, alkali metal transition metal oxide-based, vanadium-based, sulfur-based, solid solution-based (lithium-rich-based, sodium-rich-based, potassium-rich-based), carbon-based and organic substance-based positive electrode active materials are used.

As is the case with the above-described negative electrode, the positive electrode for lithium-ion secondary batteries of the present embodiment may include a skeleton forming agent. As the skeleton forming agent, the same as for the above-described negative electrode can be used, and the preferred amount of the skeleton forming agent included is also the same as for the negative electrode.

The positive electrode for lithium-ion secondary batteries of the present embodiment may include a conductive additive. As the conductive additive, a variety of conductive additives described above which can be used for negative electrodes are used. The preferred amount of the conductive additive included is also the same as for the negative electrode.

The positive electrode for lithium-ion secondary batteries of the present embodiment may include a binder. As the binder, for example, organic materials may be used individually, such as polyvinylidene difluoride (PVdF), polytetrafluoroethylene (PTFE), hexafluoropropylene, tetrafluoroethylene, polyacryl and alginic acid, or two or more of these may be used in combination. Binders obtained by mixing these organic binders and inorganic binders may be also used. Examples of inorganic binders include silicate-based, phosphate-based, sol-based, cement-based binders and the like.

The current collector used for the positive electrode is not particularly limited as long as it is a material which has electron conductivity and can apply current to a retained positive electrode active material. For example, conductive substances such as C, Ti, Cr, Ni, Cu, Mo, Ru, Rh, Ta, W, Os, Ir, Pt, Au and Al, and alloys containing two or more of these conductive substances (e.g. stainless steel and Al—Fe alloy) can be used. When using a substance other than the above conductive substances, for example, a multi-layered structure of different metals in which iron is covered with Al or different elements in which Al is covered with C may be used. The current collector is preferably C, Ti, Cr, Au, Al, stainless steel or the like from the viewpoint of high electroconductivity and high stability in an electrolyte solution, and moreover is preferably C, Al, stainless steel or the like from the viewpoint of oxidation resistance and material costs. It is more preferably Al or an Al alloy which is covered with carbon, or stainless steel which is covered with carbon.

It should be noted that as the shape of the current collector used for the positive electrode, there are line, rod, plate, foil and porous shapes, and among these, the porous shape may be used because packing density can be increased and the skeleton forming agent easily permeates into the active material layer. Examples of the porous shape include a mesh, a woven fabric, a non-woven fabric, an embossed metal, a punched metal, an expanded metal or a foam and the like. The same porous metal as for the negative electrode may be used.

[Separator]

In the lithium-ion secondary battery of the present embodiment, as a separator, those which are commonly used for lithium-ion secondary batteries can be used. For example, a polyethylene microporous film, a polypropylene microporous film, a glass non-woven fabric, an aramid non-woven fabric, a polyimide microporous film, a polyolefin microporous film and the like can be used as the separator.

[Electrolyte]

In the lithium-ion secondary battery of the present embodiment, as an electrolyte, those which are commonly used for lithium-ion secondary batteries can be used. Examples thereof include an electrolyte solution in which an electrolyte is dissolved in a solvent, a gel electrolyte, a solid electrolyte, an ionic liquid and a molten salt. Here, the electrolyte solution indicates a solution in which an electrolyte is dissolved in a solvent.

Because the electrolyte for the lithium-ion secondary battery is required to contain lithium ion as a carrier for electric conduction, the electrolyte salt is not particularly limited as long as it is an electrolyte salt which is used for lithium-ion secondary batteries, and lithium salt is suitable. As this lithium salt, at least one or more selected from the group consisting of lithium hexafluorophosphate (LiPF₆), lithium perchlorate (LiClO₄), lithium tetrafluoroborate (LiBF₄), lithium trifluoromethanesulfonate (LiCF₃SO₄), lithium bistrifluoromethanesulfonylimide (LiN(SO₂CF₃)₂), lithium bispentafluoroethanesulfonylimide (LiN(SO₂C₂F₃)₂), lithium bis oxalato borate (LiBC₄O₈) and the like can be used, or two or more of these can be used in combination.

The solvent for the electrolyte is not particularly limited as long as it is a solvent which is used for lithium-ion secondary batteries, and for example, at least one selected from the group consisting of propylene carbonate (PC), ethylene carbonate (EC), dimethyl carbonate (DMC), diethyl carbonate (DEC), ethylmethyl carbonate (EMC), g-butyrolactone (GBL), methyl-g-butyrolactone, dimethoxymethane (DMM), dimethoxyethane (DME), vinylene carbonate (VC), vinylethylene carbonate (EVC), fluoroethylene carbonate (FEC) and ethylene sulfite (ES) can be used, or two or more of these can be used in combination.

In addition, the concentration of electrolyte solution (the concentration of salt in a solvent) is not particularly limited, and is preferably 0.1 to 3.0 mol/L and further preferably 0.8 to 2.0 mol/L.

The ionic liquid and molten salt are classified into e.g. pyridine-based, alicyclic amine-based, aliphatic amine-based ionic liquids and molten salts by the type of cation (positive ion). A variety of ionic liquids or molten salts can be synthesized by selecting the type of anion (negative ion) which is combined with the cation. Examples of cation used are ammonium-based ions e.g. imidazolium salts and pyridinium salts, phosphonium-based ions, inorganic ions and the like, and examples of anion used are halogen-based ions such as bromide ion and triflate, boron-based ions such as tetraphenyl borate, phosphorus-based ions such as hexafluorophosphate, and the like.

The ionic liquid and molten salt can be obtained by, for example, a known synthesis method in which a cation such as imidazolium and an anion such as Br⁻, Cl⁻, BF⁴⁻, PF⁶⁻, (CF₃SO₂)₂N⁻, CF₃SO³⁻ or FeC⁴⁻ are combined. The ionic liquid and molten salt can function as an electrolyte solution without adding an electrolyte.

The solid electrolytes are classified into e.g. sulfide-based, oxide-based, hydride-based and organic polymer-based electrolytes. Many of these are amorphous and crystalline substances including a salt, which is a carrier, and an inorganic derivative. Unlike an electrolyte solution, a flammable aprotic organic solvent is not required, and thus ignition of gas and liquid, liquid leakage and the like do not easily occur, and it is expected that secondary batteries with excellent stability are obtained.

[Manufacturing Method]

The method for producing a lithium-ion secondary battery according to the present embodiment will now be described. The method for producing a negative electrode for lithium-ion secondary batteries according to the present embodiment has a first step of forming a negative electrode layer precursor in which the first negative electrode active material is placed in the inside of pores of the current collector made of the porous metal, by coating a negative electrode material including a negative electrode active material, a conductive additive, a binder and a fibrous material on a current collector and drying. For example, a nickel porous material with a thickness of 1000 mm is produced, and a nickel porous body is prepared by winding the material in roll form in advance. As a negative electrode material, the first negative electrode active material, is mixed with N-methyl-2-pyrrolidone or water to prepare a paste slurry. Next, the negative electrode material slurry is packed and coated in the inside of the nickel porous body, dried and then treated with adjusted pressure to obtain a negative electrode layer precursor.

It should be noted that the negative electrode layer precursor may be used in a wet state without drying as described above. In addition to the above slurry coating, for example, there is a method in which using a chemical plating method, a sputtering method, a vapor deposition method, a gas deposition method, a dipping method, a press fit method, a chemical vapor deposition method (CVD), an atomic layer deposition method (ALD) or the like, a negative electrode active material layer is formed in the inside of a porous current collector by a negative electrode active material (precursor) to unite, and the like. However, the slurry packing and coating method and dipping method are preferred from the viewpoint of the lyophilic properties of the skeleton forming agent and electrode production costs.

In the first step, the slurry of the negative electrode material may include a carbon-based material and/or the conductive additive. In this case, for example, the first negative electrode active material and the carbon-based material and/or the conductive additive are mixed with N-methyl-2-pyrrolidone or water to prepare a paste slurry, and the negative electrode layer precursor can be obtained by passing the same procedure as the first step.

In addition, the method for producing a negative electrode for lithium-ion secondary batteries according to the present embodiment has a second step of forming the skeleton of the negative electrode active material layer by impregnating the negative electrode layer precursor formed in the first step with a skeleton forming agent including a silicate having a siloxane bond or a phosphate having a phosphate bond and drying to cure the skeleton forming agent. According to the second step, the skeleton forming agent can be placed on the first negative electrode active material. For example, the silicate having a siloxane bond or the phosphate having a phosphate bond is purified by a dry or wet method, and this is adjusted with water to prepare a skeleton forming agent liquid including a skeleton forming agent. At this time, a surfactant may be mixed. As the dry method, for example, an alkali metal silicate can be produced by adding SiO; to water in which an alkali metal hydroxide is dissolved, and treating the obtained solution at 150° C. to 250° C. in an autoclave. As the wet method, for example, an alkali metal silicate can be produced by burning a mixture of an alkali metal carbonate compound and SiO₂ at 1000° C. to 2000° C., and dissolving this in hot water.

The skeleton forming agent liquid is then coated on the surface of the first negative electrode layer precursor to coat the negative electrode active material. The method for coating the surface with a skeleton forming agent can be carried out by a method in which the negative electrode layer precursor is impregnated with the skeleton forming agent liquid retained in a tank, also a method in which the skeleton forming agent is added dropwise and applied to the surface of the negative electrode layer precursor, spray coating, screen printing, a curtain method, spin coating, gravure coating, die coating or the like. The skeleton forming agent coated on the surface of the negative electrode layer precursor permeates into the inside of the negative electrode and enter into e.g. gaps between the first negative electrode active material and the conductive additive. Drying is carried out by heat treatment to cure the skeleton forming agent. Because of this, the skeleton forming agent forms the skeleton of the first negative electrode active material layer.

The above heat treatment is preferably 80° C. or higher, more preferably 100° C. or higher and desirably 110° C. or higher because the heat treatment time can be shortened and the strength of the skeleton forming agent is improved at higher temperature. It should be noted that the upper temperature limit of the heat treatment is not particularly limited as long as a current collector is not melted, and for example, the temperature may be increased to about 1000° C., which is the melting point of copper. In conventional electrodes, the upper temperature limit has been estimated at much lower than 1000° C. because a binder can be carbonized or a current collector can be softened. In the present embodiment, however, the upper temperature limit is 1000° C. because using a skeleton forming agent the skeleton forming agent shows excellent heat resistance and the strength thereof is stronger than that of a current collector.

In addition, the heat treatment can be carried out by retaining 0.5 to 100 hours. The atmosphere for heat treatment may be air; however, the treatment is preferably carried out under a non-oxidizing atmosphere to prevent the oxidation of a current collector.

Furthermore, the method for producing the negative electrode for lithium-ion secondary batteries according to the present embodiment has a third step of forming a negative electrode layer by coating a negative electrode material including the second negative electrode active material on the negative electrode layer precursor formed in the second step and drying. According to the third step, the second negative electrode active material can be placed on the skeleton forming agent. For example, the negative electrode material slurry including the prepared second negative electrode active material is packed and coated in the negative electrode layer precursor, dried and then treated with adjusted pressure to obtain a negative electrode layer precursor. In addition to the above slurry coating, for example, there is a method in which the electrode mixture including the second negative active material is allowed to introduce by packing the second negative active material in the inside of the negative electrode layer precursor to unite, using a chemical plating method, a sputtering method, a vapor deposition method, a gas deposition method, a dipping method, a press fit method or the like. However, from the viewpoint of the producing costs, the 0.0 slurry packing and coating method is preferable.

Here, the method for producing a negative electrode for lithium-ion secondary batteries in the present embodiment is controlled so that the ratio of the density B of the negative electrode layer formed in the fourth step to the density A of the negative electrode layer precursor formed in the first step, B/A, will be 0.9<B/A<1.4. Specifically, the ratio of the density B of the negative electrode layer to the density A of the negative electrode layer precursor, B/A, (i.e. density increase ratio) is controlled to obtain the above range by selecting the type of material, the amount of material, treatment conditions and the like. By doing this, the impregnated skeleton forming agent enters into the inside of the negative electrode layer, and thus the skeleton forming agent is also placed on the interface with the current collector in the negative electrode layer. Therefore, high mechanical strength is obtained and cycle life characteristics are improved due to skeleton formation by the skeleton forming agent uniformly placed on the whole negative electrode layer.

In addition, in the method for producing a negative electrode for lithium-ion secondary batteries in the present embodiment, the density A of the negative electrode layer precursor formed in the first step is 0.5 to 2.0 g/cm³. Because of this, the ratio of the density B of the negative electrode layer to the density A of the negative electrode layer precursor, B/A, (i.e. density increase ratio) can be more certainly within the above range, and the above-described effect by the skeleton forming agent can be increased. The range of the density A of the negative electrode layer precursor is more preferably 0.6 to 1.5 g/cm³. When the density A of the negative electrode layer precursor is 0.6 g/cm³ or more, a reduction in energy density due to a reduction in electrode density can be suppressed, and when the density A is 1.5 g/cm³ or less, a reduction in capacity can be suppressed.

Furthermore, the method for producing the negative electrode for lithium-ion secondary batteries according to the present embodiment may have, between the second step and the third step, a step of forming a conductive path in the negative electrode layer precursor by impregnating a conductive agent solution including the conductive additive and/or the binder on the negative electrode layer precursor formed in the second step and drying. According to the step, between the skeleton forming agent in the inside of the negative electrode layer precursor and the second negative electrode active material, the conductive additive and/or the binder can be placed. For example, the conductive additive and/or the binder are dissolved or dispersed in N-methyl-2-pyrrolidone or water to prepare a conductive agent solution. The conductive agent solution is then coated from the surface of the negative electrode layer precursor to coat the negative electrode layer precursor with the conductive agent solution. The method for coating the surface with the conductive additive solution including the conductive additive and/or the binder can be carried out by a method in which the negative electrode layer precursor is impregnated with the conductive additive solution retained in a tank, also a method in which the skeleton forming agent is added dropwise and applied to the surface of the negative electrode layer precursor, spray coating, screen printing, a curtain method, spin coating, gravure coating, die coating or the like. The conductive additive or the binder coated on the surface of the negative electrode layer precursor can place the conductive additive and/or the binder between the skeleton forming agent and the second negative electrode active material, and further permeates into the inside of the negative electrode and enter into e.g. gaps between the first negative electrode active material and the skeleton forming agent.

The positive electrode for lithium-ion secondary batteries of the present invention has a step of producing a positive electrode by coating a positive electrode material including a positive electrode active material, a conductive additive and a binder on a current collector, drying and rolling. For example, rolled aluminum foil with a thickness of 10 mm is produced, and the aluminum foil wound in roll form in advance is prepared. As the positive electrode material, a positive electrode active material, a binder, a conductive additive and the like are mixed to prepare a paste slurry. Next, the positive electrode material slurry is coated on the surface of aluminum, dried and then roll-pressed to obtain a positive electrode. A foamed porous body made of metal may be also used as a current collector. An electrode mixture is characterized by being packed in this current collector. The method for packing an electrode mixture in the current collector is not particularly limited, and for example, there is a method in which a slurry including an electrode mixture is packed in the inside of a network structure of the current collector with pressure applied by a press fit method. After packing the electrode mixture, the density of the electrode mixture can be improved by drying and then pressing the packed current collector and thus can be adjusted so that a desired density can be obtained.

Finally, the obtained negative electrode and positive electrode are each cut into a desired size and then joined to each other with a separator put between the electrodes, and a lithium-ion secondary battery can be obtained by sealing with the obtained product immersed in an electrode solution. The structure of the lithium-ion secondary battery can be applied to existing battery forms and structures such as laminated batteries and wound batteries.

### Effect

According to the present embodiment, the following effects are displayed. In the present embodiment, the negative electrode 1 for nonaqueous electrolyte secondary batteries was made, having the current collector 11 made of porous metal, and the negative electrode material 12 placed in pores of the porous metal, the negative electrode material 12 including the first negative electrode active material 13 including a silicon-based material, the skeleton forming agent 14 placed on the first negative electrode active material 13 and including a silicate having a siloxane bond and the second negative electrode active material 17 placed on the skeleton forming agent.

First, using porous metal as the current collector 11, the negative electrode material 12 can be fixed in a micron size region by a porous metal skeleton, and peeling and cracks of the negative electrode can be suppressed. In addition, the negative electrode material 12 can be fixed in a nano size region by using the skeleton forming agent 14 as the negative electrode material 12. More specifically, because the third phase by the skeleton forming agent 14 is formed on the interface between the current collector 11 made of porous metal and the negative electrode active material 13 placed on the internal surface of the pores of the current collector, falling during expansion and contraction can be suppressed by strongly binding the current collector 11 and the negative electrode active materials 13 the pores of the current collector, and durability deterioration can be suppressed.

Furthermore, by placing the second negative electrode active material 17 in a gap of the porous metal joined the first negative electrode active material 13 with the skeleton forming agent 14, that is, by placing the second negative electrode active material 17 on the skeleton forming agent 14, the second negative electrode active material 17 can contribute to suppress the fall-out of the negative electrode material 12 generated during the expansion and contraction of the first negative electrode active material 13, thus the structural deterioration of the electrode is suppressed, and an improvement in energy density and cycle durability can be realized. Accordingly, by placing the second negative electrode active material 17 on the skeleton forming agent 14 joined the first negative electrode active material 13 in the inside of the pores of the current collector 11, although the first negative electrode active material 13 made of the silicon-based material having very large expansion and contraction rate at high capacity in a negative electrode is used, even when the SOC performs a cycle of full charge/discharge, a negative electrode structure can be maintained. Therefore, high capacity by thickening the film of a negative electrode, falling when having a high basis weight, and breaking of conductive paths can be suppressed, and an improvement in cycle durability can be achieved and overwhelming high energy density can be achieved.

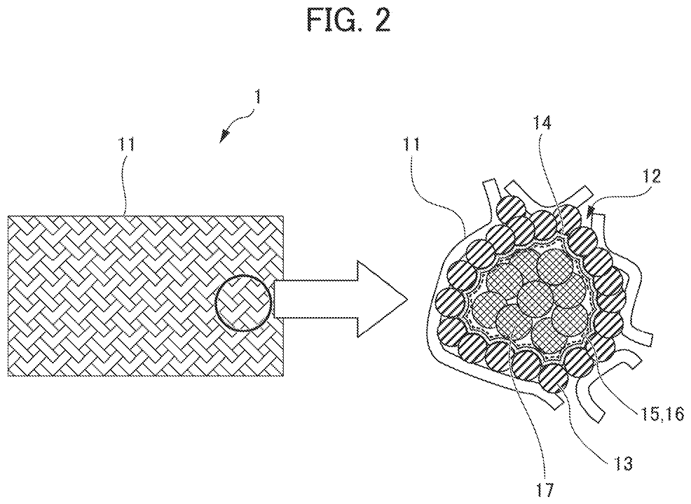

In addition to the constitution of the present embodiment, as shown in FIG. 2, when the negative electrode for nonaqueous electrolyte secondary batteries is configured by including the conductive additive 15 and/or the binder 16, other than contributing to suppress the falling of the negative electrode material 12 generated during expansion and contraction, further contributing to hold the electrode structure or to decrease of the internal resistance, the structural deterioration of the electrode is more suppressed, and an improvement of the energy density and an improvement of the cycle durability are more preferably realized. Accordingly, by forming a structure further including the conductive additive 15 and/or the binder 16 to the structure of the first embodiment, other than contributing to suppress the falling of the negative electrode material 12 generated during expansion and contraction, also contributing to hold the electrode structure and to decrease the internal resistance, although the first negative electrode active material 13 made of the silicon-based material having very large expansion and contraction rate at high capacity is used, even when the SOC performs a cycle of full charge/discharge of 0 to 100, the negative electrode structure can be more preferably maintained. Therefore, high capacity by thickening the film of a negative electrode, falling when having a high basis weight, and breaking of conductive paths can be suppressed, and an improvement in cycle durability can be achieved and overwhelming high energy density can be achieved.

It should be noted that the present invention is not limited to the above embodiment, and variants and improvements are included in the present invention as long as the object of the present invention can be achieved. For example, nonaqueous electrolyte secondary batteries are secondary batteries (storage device) using a nonaqueous electrolyte such as an organic solvent as an electrolyte, and in addition to lithium-ion secondary batteries, sodium-ion secondary batteries, potassium-ion secondary batteries, magnesium-ion secondary batteries, calcium-ion secondary batteries and the like are included. In addition, lithium-ion secondary batteries are secondary batteries having a nonaqueous electrolyte not containing water as a main component, and mean batteries including lithium ion as a carrier for electric conduction. For example, lithium-ion secondary batteries, lithium metal batteries, lithium polymer batteries, all-solid lithium batteries, lithium-ion air batteries and the like correspond thereto. The same applies to other secondary batteries. Here, the nonaqueous electrolyte not containing water as a main component means that the main component in an electrolyte is not water. That is, it is a known electrolyte used for nonaqueous electrolyte secondary batteries. This electrolyte can function as a secondary battery even when containing a little amount of water; however, water has bad effect on cycle characteristics, storage characteristics, and input and output characteristics of secondary batteries, and thus it is desired that an electrolyte contain water as little as possible. Realistically, water in an electrolyte is preferably 5000 ppm or less.

### EXAMPLES

Examples of the present invention will now be described. It should be noted, however, that the present invention is not limited to these examples.

### Example 1

### [Production of Negative Electrode]

A slurry including silicon (particle diameter 1 to 3 mm) as the first negative electrode active material and the conductive additive shown in Table 1, was prepared. The prepared slurry was then packed in “Nickel Celmet” (registered trademark) manufactured by Sumitomo Electric Industries, Ltd. as the current collector, dried and then treated with adjusted pressure to obtain a negative electrode layer precursor.

A 10 mass aqueous solution of K₂O.3SiO₂ was prepared as a skeleton forming agent liquid including the skeleton forming agent and water. The negative electrode layer precursor obtained above was immersed in the prepared skeleton forming agent liquid. After immersion, the negative electrode precursor was heated and dried at 160° C. to obtain a negative electrode having a negative electrode layer formed therein.

A conductive agent solution including a conductive additive and polyvinylidene difluoride (PVdF) as a binder shown in Table 1 was prepared. In the prepared conductive agent solution, the negative electrode layer precursor obtained in the above was immersed. After immersion, the negative electrode precursor was then obtained by drying.

As a second negative electrode active material, a slurry including a compound shown in Table 1 was prepared.

the prepared slurry was then packed in the negative electrode layer precursor obtained above, followed by drying, a negative electrode in which a negative electrode layer was formed was obtained.

[Production of Positive Electrode]

LiNi_{0.5}C_{0.2}Mn_{0.3}O₂ (particle diameter 5 to 15 mm) was prepared as a positive electrode active material. Ninety four mass % of the positive electrode active material, 4 mass % of carbon black as the conductive additive, and 2 mass % of polyvinylidene difluoride (PVdF) as a binding agent were mixed, and the obtained mixture was dispersed in a proper amount of N-methyl-2-pyllolidone (NMP) to produce a positive electrode mixture slurry. Foamed aluminum with a thickness of 1.0 mm, a porosity of 95%, 46 to 50 cells/inch, a pore diameter of 0.5 mm and a specific surface area of 5000 m²/m³ was prepared as a current collector. The produced positive electrode mixture slurry was applied to the current collector by a press fit method so that the coated amount was 90 mg/cm².

The current collector was dried in vacuum at 120° C. for 12 hours, and then roll-pressed at a pressure of 15 ton to produce a positive electrode for lithium-ion secondary batteries, in which the electrode mixture was packed in pores of foamed aluminum.

[Production of Lithium-Ion Secondary Battery]

A microporous film with a thickness of 25 mm, a three layer laminated body of polypropylene/polyethylene/polypropylene, was prepared as a separator, and was punched out in 100 mm in length×90 mm in width. The positive electrode for lithium-ion secondary batteries and the negative electrode for lithium-ion secondary batteries obtained above are laminated in the order of positive electrode/separator/negative electrode/separator/positive electrode/negative electrode to produce an electrode laminated body.

A tab lead was then joined to a collecting region of each electrode by ultrasonic welding. The electrode laminated body having the tab lead welded and joined thereto was inserted into an aluminum laminate for secondary batteries processed into the form of bag by heat sealing to produce a laminate cell. Ethylene carbonate, dimethyl carbonate and ethyl methyl carbonate were mixed in a volume ratio of 3:4:3, and in the obtained solvent, 1.2 mol LiPF₆ was dissolved to prepare a solution as an electrolyte solution, and the electrolyte solution was injected into the above laminate cell to produce a lithium ion secondary battery.

### Examples 2 to 4

As the second negative electrode active material, a slurry including a negative electrode active material shown in Table 1 was prepared. Next, the prepared slurry was packed in the negative electrode layer precursor same as Example 1, followed by drying, the negative electrode layer of examples 2 to 4 were obtained.

It should be noted that the positive electrodes of Examples 2 to 4 were prepared in the same way as Example 1, other than a coating amount of Example 1 was changed to 45 mg/cm². Furthermore, producing of the battery was performed in the same way as the Example 1.

### Comparative Example 1

Other than that the second negative electrode active material was not used during producing the negative electrode, the negative electrode was produced in the same way as Examples 1 to 4.

It should be noted that the positive electrode of Comparative Example 1 was produced in the same way as Example 1 other than that the coating amount of Example 1 was changed to 45 mg/cm². Furthermore, producing of the battery was prepared in the same way as Example 1.

[Aging Test]

To each of Examples and Comparative example, an aging test was performed. The aging test was performed at a test environment temperature of 25° C.

[Durability Test]

To each of Examples and Comparative example, a cycle life test was performed. The cycle life test was performed at a test environment temperature of 25° C., a current density of 0.2C-rate, a cut-off voltage of 2.5 to 4.2 V.

TABLE 1

| | | | Amount of | | Total | | | |
|---|---|---|---|---|---|---|---|---|
| | | | skeleton | | basis | | Second | |
| | | | forming | | weight | Thickness | negative | |
| | | Skeleton | agent | | of active | of | electrode | Active |
| | Current | forming | coated | | material | electrode | active | material |
| | collector | agent | (mg/cm²) | Composition | (mg/cm²) | (μm) | material | ratio |
| Example | Foamed | K₂O•3SiO₂ | 0.89 | Active material/ | 9.4 | 170 | SiO | Si/SiO: |
| 1 | Ni | | | AB/PVdP = | | | | 55/45 |
| | | | | 90/5/5 (mass %) | | | | (mass %) |
| Example | Foamed | K₂O•3SiO₂ | 0.95 | Active material/ | 19.2 | 356 | Gr | Si/Gr: |
| 2 | Ni | | | AB/PVdP = | | | | 27/73 |
| | | | | 90/5/5 (mass %) | | | | (mass %) |
| Example | Foamed | K₂O•3SiO₂ | 1.01 | Active material/ | 25.8 | 428 | Gr | Si/Gr: |
| 3 | Ni | | | AB/PVdP = | | | | 22/78 |
| | | | | 90/5/5 (mass %) | | | | (mass %) |
| Example | Foamed | K₂O•3SiO₂ | 0.96 | Active material/ | 40.2 | 595 | Gr | Si/Gr: |
| 4 | Ni | | | AB/PVdP = | | | | 27/73 |
| | | | | 90/5/5 (mass %) | | | | (mass %) |
| Comparative | Foamed | K₂O•3SiO₂ | 0.93 | Active material/ | 9.5 | 146 | — | Only |
| Example | Ni | | | AB/PVdP = | | | | Si: 100 |
| 1 | | | | 90/5/5 (mass %) | | | | (mass %) |

Notice:
Gr is graphite.
Furthermore, “—” shows no use.

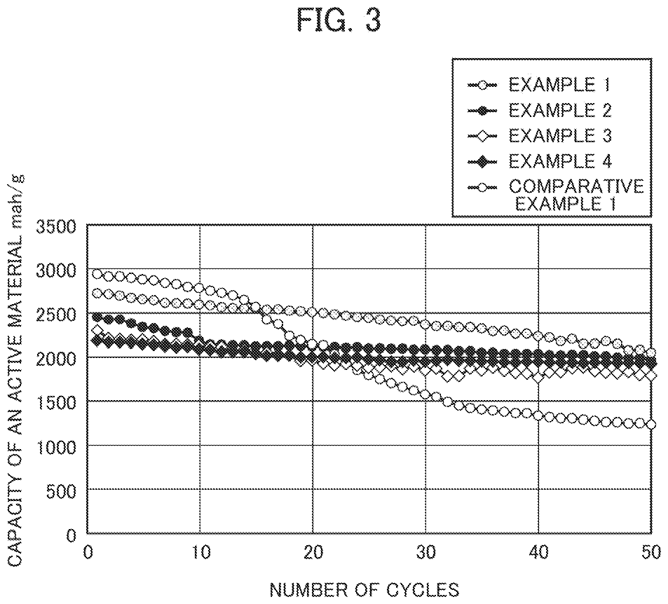

FIG. 3 is a diagram showing relation between number of cycles and the capacity of active material (mAh/g) of examples 1 to 4 and a comparative example 1. As obvious from FIG. 3, according to the present examples, since a decrease amount of the active material capacity is small even when the number of cycles increases, it was confirmed that a negative electrode for nonaqueous electrolyte secondary batteries capable of suppressing the durability deterioration and the structural deterioration of the electrode and improving the energy density and the cycle durability and an a nonaqueous electrolyte secondary battery including the same can be obtained.

### EXPLANATION OF REFERENCE NUMERALS

1: Negative electrode for nonaqueous electrolyte secondary batteries
11: Current collector
12: Negative electrode material
13: First negative electrode active material (negative electrode made of silicon-based material)
14: Skeleton forming agent
15: Conductive additive
16: Binder
17: Second negative electrode active material

What is claimed is:

1. A negative electrode for nonaqueous electrolyte secondary batteries, having
a current collector made of porous metal, and a negative electrode material placed in pores of the porous metal,
the negative electrode material comprising:
a first negative electrode active material placed on an internal surface of the pores and comprising a silicon-based material;
a skeleton forming agent placed on the first negative electrode active material and including a silicate having a siloxane bond; and
a second negative electrode active material placed on the skeleton forming agent.

2. The negative electrode for nonaqueous electrolyte secondary batteries according to claim 1, wherein the negative electrode material further includes a conductive additive placed between the skeleton forming agent and the second negative electrode material.

3. The negative electrode for nonaqueous electrolyte secondary batteries according to claim 1, wherein the negative electrode material further includes a binder.

4. The negative electrode for nonaqueous electrolyte secondary batteries according to claim 1, wherein the skeleton forming agent includes a silicate represented by general formula (1) below:
[Chem. 1]
A₂O.nSiO₂ formula (1)
[in the above general formula (1), A represents an alkali metal].

5. The negative electrode for nonaqueous electrolyte secondary batteries according to claim 1, wherein the porous metal is a foamed metal.

6. A nonaqueous electrolyte secondary battery, comprising the negative electrode for nonaqueous electrolyte secondary batteries according to claim 1.
